(19) United States
(12) Patent Application Publication
(10) Pub. No.: US 2016/0005209 A1
(43) Pub. Date: Jan. 7, 2016

(54) METHOD AND SYSTEM FOR LIGHT TRANSPORT PATH MANIPULATION

(71) Applicant: Karlsruher Institut für Technologie, Karlsruhe (DE)

(72) Inventor: Carsten Dachsbacher, Karlsruhe (DE)

(21) Appl. No.: 14/324,301

(22) Filed: Jul. 7, 2014

(51) Int. Cl. G06T 15/06; G06T 19/20; G06T 15/50

(52) U.S. Cl. CPC G06T 15/06; G06T 15/50; G06T 19/20; G06T 2200/24; G06T 2219/2012

(57) ABSTRACT

A computer system, computer implemented method and computer program product for light transport path manipulation. A three-dimensional virtual scene description is received. The scene description includes location properties and optical behavior properties of a plurality of three-dimensional virtual objects and at least one virtual light source. The system generates at least one portion of a particular light transport path within the three-dimensional scene by applying a ray tracing based-light transport algorithm to the scene description. A comparator compares the at least one portion of the particular light transport path with a path selection scheme. The path selection scheme defines a sub-space of the entire path space wherein the entire path space is defined by the ray tracing-based light transport algorithm describing the distribution of light in the three-dimensional scene. If the at least one portion of the particular light transport path does not match the path selection scheme, the least one portion of the particular light transport path is left unchanged. If the at least one portion of the particular light transport path matches the pre-defined path selection scheme, the at least one particular portion of the particular light transport path is modified in accordance with a modification request associated with the orientation of at least one particular portion of the particular light transport path. The system computes a contribution of the particular light transport path to a pixel location of an image of the three-dimensional scene. The system then repeats the generating, comparing, modifying and computing steps for a plurality of light transport paths.

### TECHNICAL FIELD

The present invention generally relates to electronic data processing, and more particularly, relates to methods, computer program products and systems for digital scene illumination.

### BACKGROUND

Digital picture and video creation is widely used, for example, in industries such as movie production, architectural visualization, product visualization, lighting design, and computer and video games. It relies on tools for so-called lighting artists to quickly prototype, iterate, and refine final renders of the pictures or videos. Lighting artists typically set up and adjust the lighting of three-dimensional scenes.

A well-adopted method for picture generation is ray tracing-based rendering, which can be used to simulate the propagation of light through a virtual scene. This simulation may solve the governing equations of physical light behavior, which are given by the radiative transfer equation (cf., “Radiative Transfer”, CHANDRASEKHAR S., Dover Publications, 1960), but also simplifications thereof, which are computationally less expensive to solve. Ray tracing-based methods create a multitude of light paths, which start at virtual light sources and end at virtual sensors which measure the illumination in at least parts of the scene.

When producing photorealistic images that are as close as possible to physical reality, the picture generation process is commonly called physically based rendering (PBR). Generally, PBR systems simulate, store, and operate on radiometric quantities and operators. The commercial availability of PBR systems with progressive pre-visualization has promoted rapid adoption of PBR standards in the feature-film, gaming, and other industries.

Existing lighting design toolsets used by lighting artists only provide limited capabilities for refining and controlling the final renders. For example, they address simple, specific lighting effects without considering underlying light transport concepts and constraints, limiting artists' productivity, because they require many iterations until a desired artistic lighting effect is achieved.

Kerr et al.'s method (“BendyLights: artistic control of direct illumination by curving light rays”, KERR, W. B., PELLACINI, F., AND DENNING, J. D., 2010, Computer Graphics Forum (Proc. EGSR) 29, 4, 1451-1459) directs the path of direct illumination along curved volumetric frusta, but the editing is limited to direct illumination from point light sources.

The method disclosed by Ritschel et al. (“Interactive reflection editing”, RITSCHEL, T., OKABE, M., THORMÄHLEN, T., AND SEIDEL, H.-P., 2009, ACM Transactions on Graphics (Proc. SIGGRAPH Asia) 28, 5, 129:1-129:7) lets users specify constraints on mirror surfaces to infer modified reflections. Nowrouzezahrai et al. (“A programmable system for artistic volumetric lighting”, NOWROUZEZAHRAI, D., JOHNSON, J., SELLE, A., LACEWELL, D., KASCHALK, M., AND JAROSZ, W., 2011, ACM Transactions on Graphics (Proc. SIGGRAPH) 30, 4, 29:1-29:8) designed a tool for artistic manipulation of volumetric lighting, which is integrated into existing production pipelines; this facilitated and promoted its adoption in the industry, but the editing is limited to volumetric light beams. Obert et al. (“iCheat: A representation for artistic control of indirect cinematic lighting”, OBERT, J., KRIVANEK, J., PELLACINI, F., SYKORA, D., AND PATTANAIK, S. N., 2008, Computer Graphics Forum (Proc. EGSR) 27, 4, 1217-1223) use a painting interface to edit the intensity and color of indirect light, while enforcing physical constraints on the resulting appearance. Similarly, Tabellion and Lamorlette (“An approximate global illumination system for computer generated films”, TABELLION, E. AND LAMORLETTE, A, 2004, ACM Transactions on Graphics (Proc. SIGGRAPH) 23, 3, 469-476) use shader falloff-function editing on the hue of indirect color bleeding effects to achieve simple effects. These methods do not provide accurate control over the propagation direction of light transport phenomena.

“Interactive on-surface signal deformation (“Interactive on-surface signal deformation”, RITSCHEL, T., THORMÄHLEN, T., DACHSBACHER, C., KAUTZ, J., AND SEIDEL, H.-P., 2010, ACM Transactions on Graphics (Proc. SIGGRAPH) 29, 4, 36:1-36:8) is a tool for manipulating shadows, caustics and indirect illumination with a click-and-drag interface. However, this method only considers the shading signal on surfaces and thus requires a surface parameterization, limiting its applicability with dynamic scenes.

The above described prior art work falls short to support the user in manipulating complex illumination effects. A complex illumination effect, as used hereinafter, includes one or multiple interactions of light with matter (e.g., surfaces, materials, etc.) in various directions.

### SUMMARY

There is a need to further improve the prior art approaches to manipulating a simulated illumination of a three-dimensional scene with complex illumination effects or complex light transport phenomena in a quasi-consistent manner. Quasi-consistent in this context means that there may be deviations from the original illumination simulation (e.g., a close model of physical reality) which serve some visual purpose (e.g., artistic effect), but the deviation affects a specific illumination component so that an observer can still accept the deviations to be part of a realistic picture, image or video. In other words, one aspect is to achieve consistency and generality in that for example a manipulated illumination remains as plausible as possible for the observer without restricting artistic freedom.

The following disclosure provides a light transport manipulation technique that operates directly on path-space solutions produced by ray tracing-based rendering methods. It allows, but is not limited to, exposing intuitive manipulation approaches to edit complex effects such as (multi-refracted) caustics, diffuse and glossy indirect bounces, and direct/indirect shadows. A light transport path is defined as the complete path of a light ray starting at a virtual light source and ending at a virtual observer or at a pixel of an environment map including all in-between interactions with virtual objects of the three-dimensional scene. The terms “light transport path” and “transport path” are used as equivalents hereinafter. Light transport paths can be classified and filtered on the fly (while rendering a respective image) and the selected transport phenomena can be visualized. The disclosed method, computer program product and computer system allow manipulating complex illumination phenomena in static and/or animated scenes through a tool built on ray tracing-based global illumination renderers to enable rapid and intuitive selection and manipulation of light transport, including effects that result from complex transport paths. In the context of this application, a renderer is a computer program which is configured to generate an image to be displayed on a display device (e.g., computer monitor). In contrast to prior art solutions, the proposed manipulation of transport paths operates entirely in the space of transport paths (path space), rather than targeting specific shading phenomena. Considering the entire path space poses several technical challenges when making no prior assumptions on the form of transport.

In one embodiment, the disclosed methods, systems and computer program products allow to interactively cluster (i.e., group together) transport paths according to user-selected feature(s) and, in one embodiment, to provide a visualization of clustered paths. In other words, a single graphical representation can be used to visualize a plurality of clustered transport paths.

In one embodiment, a computer implemented method for light transport path manipulation is disclosed. The method includes receiving a three-dimensional virtual scene description. The scene description includes location properties and optical behavior properties of a plurality of three-dimensional virtual objects, at least one virtual light source, and, optionally, a virtual observer. At least one portion of a particular light transport path is generated, for example during image generation, within the three-dimensional scene by applying a ray tracing-based light transport algorithm to the scene description. The at least one portion of the particular light transport path is compared with a path selection scheme wherein the path selection scheme defines a sub-space of the entire path space. The entire path space is defined as the space containing all light transport paths in the scene. If the at least one portion of the particular light transport path does not match the path selection scheme, the at least one portion of the particular light transport path is left unchanged. If the at least one portion of the particular light transport path matches the pre-defined path selection scheme, at least one particular portion of the particular light transport path is modified in accordance with a modification request. The modification request is associated with the orientation of at least one particular portion of the particular light transport path. In other words, the modification request specifies a modification with regards to a redirection of at least one particular portion of the particular light transport path. The selection condition regarding the match of the at least one portion of the particular light transport with the path selection scheme may be based on a probability associated with the at least one portion of the particular light transport path. In one embodiment, such probability can be statically assigned to the respective light transport path and describe the probability that the transport path is selected for modification when matching the path selection scheme. In one embodiment, such probability can be determined dynamically while the transport path is being generated. For example, the probability may depend on the location of the transport path in the scene and may vary with the location. Using a probability for the selection of transport paths for manipulation allows smoothing of modification effects, as not all transport paths matching the path selection scheme are modified.

Then, the contribution of the particular light transport path to a pixel location of an image of the three-dimensional scene can be computed. For example, the contribution of the particular light transport path to a pixel location of the image can be computed for a virtual observer or an environment map, or with regards to a memory buffer storing the result of the ray tracing-based light transport algorithm. The contribution of the particular light transport path to a pixel location may be computed, for example, for the virtual observer's viewpoint. The contribution may also be computed to a pixel of an environment map which is known by a person skilled in the art of virtual scene illumination. Then, the part of the method starting with transport path generation up to and including the computation of the pixel contribution of the transport path is repeated for a plurality of light transport paths.

In one embodiment, a particular light transport phenomenon may be visualized using appropriate display means. In the context of this description a light transport phenomenon corresponds to a visible illumination structure, such as for example, a refractive caustic (i.e., light that has been focused by a glass sphere). For example, a single transport path may be visualized, a cluster or group of transport paths may be visualized, or an abstract depiction (glyph) of the light transport may be visualized. For example, additional geometry and images (e.g., arrows or other appropriate symbols), which are not part of the scene description, may be used for visualization of a cluster of transport paths. For example, a group or cluster of path segments may be visualized by a representing arrow. For example, the statistical distribution of directions of surface reflection can be visualized as a polar plot.

In one embodiment, the particular light transport path is an element of the entire path space associated with the three-dimensional scene. The particular light transport path originates at a light source and may end at the virtual observer. However, the particular path does not necessarily need to reach the virtual observer. Thereby, in one embodiment, the entire path space can be defined by a radiative transfer equation describing the distribution of light in the three-dimensional scene and the respective light transport algorithm. The so-called rendering equation is a specific embodiment of the radiative transfer equation which describes the light transport in scenes including surfaces surrounded by vacuum. In other embodiments, any other rendering method configured to compute transport paths from the light source to the observer allowing for a sensible definition of a path space may be used instead.

In one embodiment, the path selection scheme is received from a user via a light editing user interface prior to comparing at least a part of the particular light transport path with the path selection scheme. For example, the selection scheme may be defined by the user through an appropriate editing tool using regular expressions.

In one embodiment, the path selection scheme is based on the order of transport path interactions with virtual objects. In other words, such transport paths are automatically selected which interact with a given number of virtual objects in a given order. Interactions with virtual objects in the three-dimensional scenes include but are not limited to: emission, reflection, transmission, scattering, and absorption.

In one embodiment, the ray tracing-based light transport algorithm is a path sampling algorithm configured to sample the transport path space. The path sampling algorithm may belong to but is not limited to the classes of: approximate methods (e.g. “An improved illumination model for shaded display”, WHITTED, T., 1980, Communications of the ACM 23, 6, 343-349), Monte Carlo methods (such as Distributed Ray Tracing (cf. “Distributed ray tracing”, COOK, R. L., PORTER, T., and CARPENTER, L., 1984, ACM SIGGRAPH Computer Graphics (Proc. SIGGRAPH) 18, 3, 137-145), Path Tracing (cf. “The rendering equation”, KAJIYA, J. T., 1986, Proc. SIGGRAPH, 143-150), Light Tracing (cf. “Backward ray tracing”, ARVO, J., 1986, “Developments in ray tracing” (Proc. SIGGRAPH Courses), 259-263), Bidirectional Path Tracing (cf. “Bi-Directional Path Tracing”, LAFORTUNE, E. P., and WILLEMS, Y. D., 1993, Proc. of CompuGraphics, 145-153), or Instant Radiosity (cf. “Instant Radiosity”, KELLER, A., 1997, ACM SIGGRAPH Computer Graphics (Proc. SIGGRAPH), 49-56)), Quasi-Monte Carlo methods, Markov Chain Monte Carlo methods (such as Metropolis Light Transport (cf. “Metropolis light transport”, VEACH, E. and GUIBAS, L. J., 1997, Proc. SIGGRAPH, 65-76)), sequential Monte Carlo methods, population Monte Carlo methods, and hybrid methods (cf. “Energy Redistribution Path Tracing”, CLINE, D., and TALBOT, J., and EGBERT, P., 2005, ACM Transactions on Graphics (Proc. SIGGRAPH) 24, 3, 1186-1195, and “Robust Monte Carlo Methods for Light Transport Simulation” (VEACH, E., 1997, PhD Dissertation, Stanford University).)

In another embodiment, the ray tracing-based light transport algorithm may create light paths with “fuzzy” connections, as in density estimation methods (e.g. Photon Mapping (cf. “Realistic image synthesis using photon mapping”, JENSEN, H. W., 2001, AK Peters) or Vertex Connection and Merging (cf. “Light Transport Simulation with Vertex Connection and Merging” GEORGIEV, I., KRIVANEK, J., and DAVIDOVIC, T., and SLUSALLEK, P., 2012, ACM Transactions on Graphics (Proc. SIGGRAPH) 31, 6, 192:1-192:10), or regularization methods (cf. “Path Space Regularization for Holistic and Robust Light Transport”, KAPLANYAN, A., and DACHSBACHER, C., 2013, Computer Graphics Forum (Proc. Eurographics) 32, 2, 63-72). For example, some ray tracing-based light transport algorithms construct transport paths in such a manner that one or multiple consecutive path segments are constructed starting from a light source origin (“light sub-path”) and another one or multiple consecutive path segments are separately constructed starting at the end of the transport path (“eye sub-path”) and going backwards. It may occur that the ends of the two sub-paths do not exactly meet. If the positions of the neighboring ends of the two segments are sufficiently close the ends of the two sub-paths can be merged into one. Thereby, the exact place of interaction is freely selectable. For example, one may choose as place of interaction (vertex) the end of the first sub-path or the end of the second sub-path or an average value. In some ray tracing-based light transport methods, two sub-paths can also be connected by an additional connecting path segment.

In one embodiment, the modification request specifies a modification of a transport phenomenon of the particular light transport path at at least one affected vertex of the particular light transport path. In other words, an affected vertex corresponds to an interaction point of a transport path with a virtual object. In other words, a vertex as used hereinafter, relates to any place of interaction along the light transport path. For such a vertex it can be defined how one or more transport phenomena are affected through the interaction. The modification request specifies how these one or more transport phenomena are to be manipulated.

For example, in one embodiment, the transport phenomenon may relate to the direction of at least one portion of the particular light transport path starting at the at least one affected vertex. This at least one portion may then be redirected from a first virtual (source) object towards a second virtual (target) object, wherein the first virtual (source) object may be spatially separated from the second virtual (target) object in the three-dimensional scene.

In one embodiment, a portion of a transport path matching the selection scheme will be modified according to the modification request with the respective probability. If the resulting, modified transport path has one or more portions matching another path selection scheme, it is modified again. That is, a transport path can be modified or manipulated multiple times during the same image creation process.

In a further embodiment, the transport phenomenon may relate to an optical property of a surface associated with the at least one affected vertex. For example, the optical property may refer to how glossy or matt the material is, and/or it may relate to the color of the surface, or to any other optical property which influences the properties of the affected portion(s) of the manipulated light transport path.

In a further embodiment, the transport phenomenon may relate to an optical property of the virtual light source, such as for example, the intensity or the frequency spectrum of the virtual light source.

In one embodiment, computer program instructions are loaded into a memory of a computer system and are executed by at least one processor of the computer system causing the computer system to execute the steps of the respective computer implemented method for performing the above described functions.

In a further embodiment, the computer program instructions may be stored on a computer readable medium forming a computer program product.

Further aspects of the invention will be realized and attained by means of the elements and combinations particularly depicted in the appended claims. It is to be understood that both the foregoing general description and the following detailed description are exemplary and explanatory only, and are not restrictive of the invention as described.

### BRIEF DESCRIPTION OF THE DRAWINGS

FIG. 1 is a simplified flow chart of a computer implemented method for light transport path manipulation according to an embodiment of the invention;

FIG. 2 is a simplified component diagram of a computer system for executing the computer implemented method according to an embodiment of the invention;

FIG. 3 shows a three-dimensional virtual scene with virtual objects, virtual light source and virtual observer;

FIG. 4 shows an example of transport path manipulation according to an embodiment of the invention;

FIG. 5 illustrates the selection and filtering process of light transport paths according to an embodiment of the invention; and

FIG. 6 is a diagram that shows an example of a generic computer device and a generic mobile computer device, which may be used in embodiments of the invention.

### DETAILED DESCRIPTION

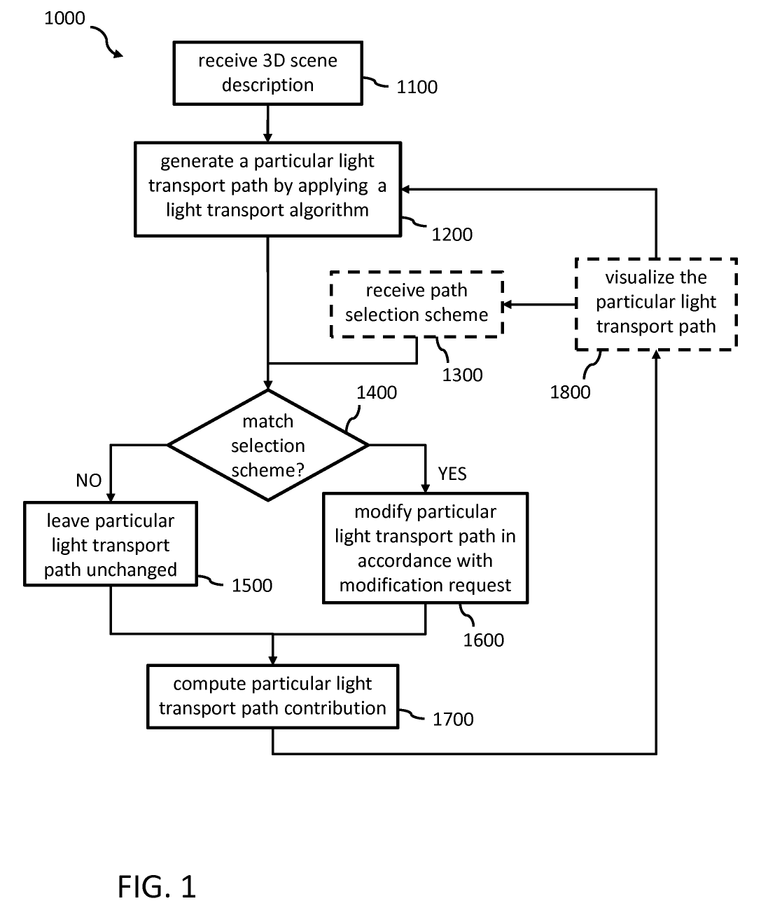

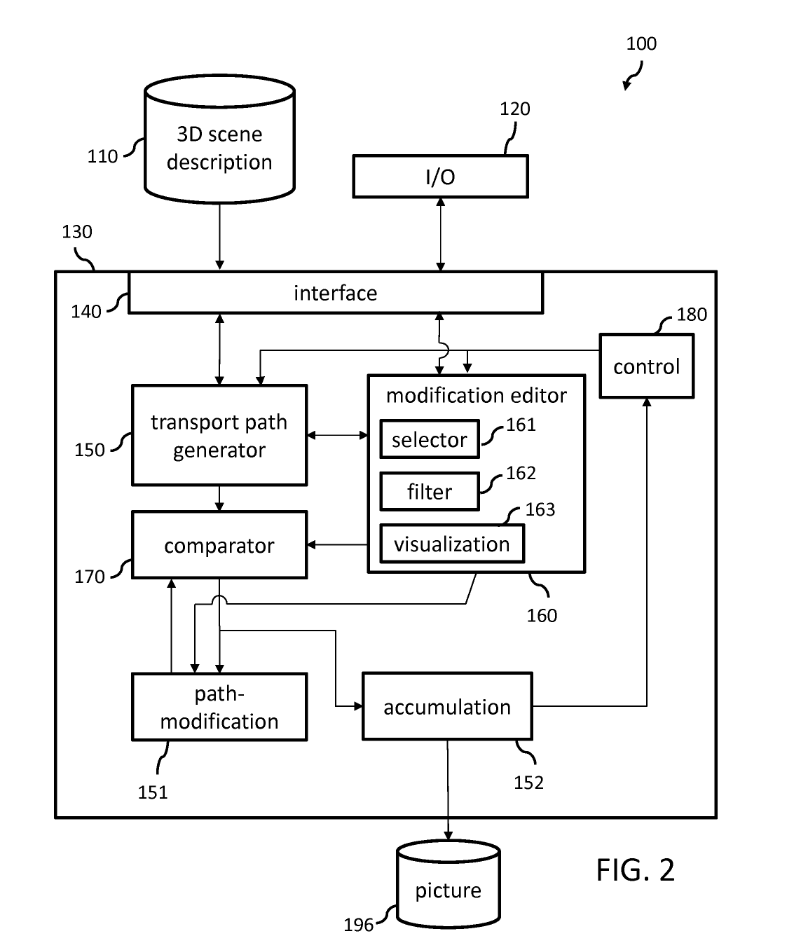

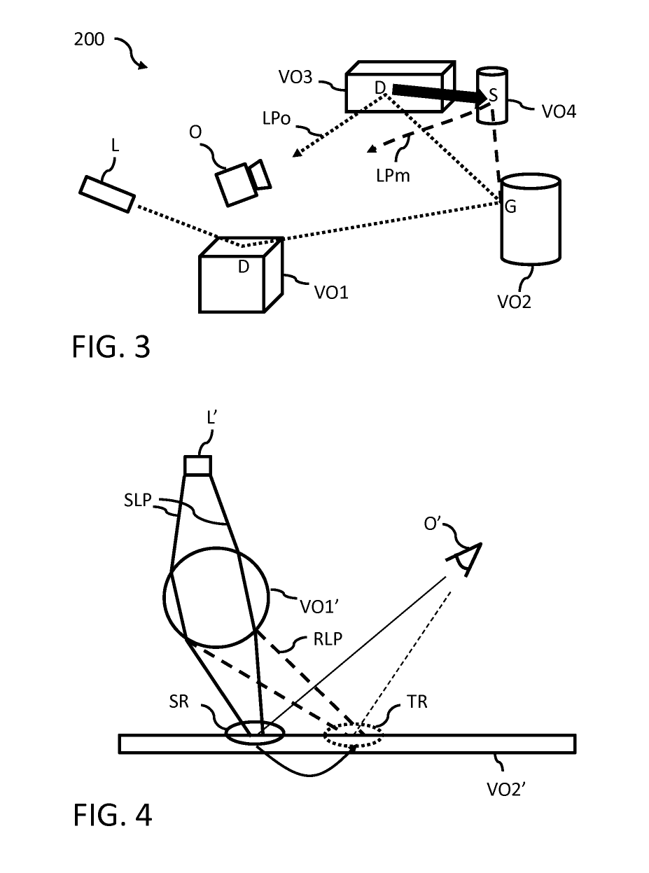

FIG. 1 and FIG. 2 are described in the context of the example scene scenario illustrated in FIG. 3.

FIG. 1 is a simplified flow chart of a computer implemented method 1000 for light transport path manipulation according to an embodiment of the invention. The steps of method 1000 can be executed by, for example, respective components of a computer system 100 as illustrated in FIG. 2.

The computer implemented method 1000 for light transport path manipulation starts with receiving 1100 a three-dimensional virtual scene description which includes location properties and optical behavior properties of a plurality of three-dimensional virtual objects VO1 to VO4, at least one virtual light source L, and a virtual observer O.

Regarding the example three-dimensional scene 200 as illustrated in FIG. 3, a description of a particular three-dimensional object VO1 to VO4 may, for example, include a set of location parameters specifying a location of the object within the three-dimensional scene 200. For example, location parameters may be expressed as Cartesian coordinates of the object or as a vector with a respective angle within a coordinate system defined for the three-dimensional scene 200. The description of the particular object may further include a description of the shape and orientation of the virtual object. For example, VO1 is a cube with a given edge length and a given orientation in the coordinate system of scene 200. VO3 is a cuboid with given geometric parameters and orientation. VO2 and VO4 are two different cylinders with different geometric parameters at different locations but having the same orientation (of the central axes). The geometry or shape of virtual objects can be defined in other appropriate ways, e.g. as triangle or polygon meshes, parametric surfaces, subdivision surfaces, point set surfaces, constructive solid geometry, or voxelizations. Each object description further has one or more optical surface properties specifying an optical behavior of the surface of the respective virtual object. Virtual objects can represent participating media or translucent materials, such as smoke, clouds, or marble, where light interactions take place also, or only, inside the object. Virtual objects also can be animated to generate motion in the image.

The scene description further includes a description of the at least one virtual light source L. The at least one virtual light source description includes at least a light direction distribution, and a frequency spectrum characterizing the intensity of the virtual light source. In other words, the virtual light source description includes the characteristics of its emission profile (spatio-angular, spectral). The frequency spectrum may include a single frequency only (monochromatic light source). Virtual light sources may also include (but are not limited to) spatial extent of the emission (so-called area lights) as well as background illumination from the environment, specified by e.g. images or textures (so called image-based lighting or environment mapping, cf. “Physically Based Rendering, Second Edition: From Theory to Implementation”, PHARR, M., HUMPHREYS, G., 2004, Morgan Kaufmann Publishers).

Optionally, the scene description further may include a description of the virtual observer O. A virtual observer (e.g., a camera, a spectator, a measurement device, etc.) corresponds to an entity observing the scene from a particular viewpoint. The virtual observer description has at least a set of location parameters specifying the location of the virtual observer in relation to the coordinate system of the three-dimensional scene 200 and a view orientation parameter specifying a viewing direction of the virtual observer. Virtual observers in specialized applications may include an omnidirectional rendering into a so-called environment map (using projection schemes such as, e.g., latitude-longitude, sphere mapping, paraboloid mapping, etc.), which create an image (or array of images) of the entire surroundings of a specific location within the virtual scene.

The scene description may be stored in respective storage means 110 which is communicatively coupled (e.g., via the interface component 140) with the computer 130. The storage means 110 can also be an integral part of the computer 130.

Based on the scene description, a rendering program can generate a picture, parts of a picture, or intermediate data for generating a picture or parts of it, as well as sequences of the aforementioned of the three-dimensional scene, which may be displayed to a user (e.g., lighting artist), for example on a display device coupled with the computer system 100.

A transport path generator component 150 can generate 1200 a particular light transport path LPo (cf. FIG. 3) within the three-dimensional scene by applying a ray tracing-based light transport algorithm to the scene description. Known light transport algorithms include path sampling algorithms which are configured to sample the light path space. Examples of such transport path sampling algorithms are: Monte Carlo methods, Quasi-Monte Carlo methods, Markov Chain Monte Carlo methods, sequential Monte Carlo methods, population Monte Carlo methods, approximate methods, and hybrid methods. Known light transport algorithms also include path sampling algorithms using, for example, density estimation methods and regularization-based methods.

In the example of FIG. 3, the virtual light source L emits a virtual light ray, illustrated by the dotted line as corresponding transport path LPo. The transport path LPo shows the interaction of the emitted light with the surfaces of the virtual objects VO1 to VO3 as originally computed by the light transport algorithm. The computation of multiple transport paths originating at the virtual light source can lead to a progressive rendering, converging to the actual solution of the underlying governing equations, describing the behavior of light within the three-dimensional scene (which may be the radiative transfer equation, the so-called rendering equation, or any simplification/extension thereof). Alternatively, e.g. in case of sufficient computational power, the final image of the scene may be rendered in one shot instead of progressively. Progressive rendering may be perceived by the virtual observer O as a stepwise increase in the quality of illumination of the virtual scene, as seen in the image. The computation of a plurality of transport paths may be performed in parallel by using appropriate parallelized computing resources.

There may be reasons why a user of the computer system 100 would like to change the originally computed illumination of the scene. For example, because of aesthetic considerations, the user may want to emphasize one particular object VO4 in the scene over another particular object VO3. As a result of the ray tracing-based rendering, the originally computed transport path LPo, however, does not contribute to the illumination of VO4. Therefore, there may be the desire to select certain transport paths in accordance with a path selection scheme for adjustment of their respective contributions to the illumination of the scene. For example, by using a selector component 161, a user may indicate an area in the three-dimensional scene which is supposed to be subject to manipulation with regards to the illumination effects computed by the ray tracing-based transport algorithm. This user interaction may define a path selection scheme which refers to all transport paths having an interaction vertex with VO3. Another option for defining a path selection scheme for the scene of FIG. 3 is to select all transport paths which have an interaction, for example, with the virtual objects VO1, VO2 and VO3 in this order. Other possibilities for selecting transport paths may be used as well without departing from the spirit of the general concept of transport path manipulation. For example, the path selection scheme can be generated by the filter component 162. The modification editor 160 may also include a visualization component 163 which is adapted to visualize the generated path selections scheme to the user. In the example embodiment of FIG. 2 the selector 161, filter 162 and visualization 163 components are shown as sub-components of the modification editor component 160 because they provide user interaction functions for defining the modification request of the user. However, they may also be implemented as stand-alone components or as sub-components of any other appropriate component of system 100.

A comparator component 170 of the computer system 100 can compare 1400 the particular (original) light transport path LPo, or at least a portion of LPo, with the path selection scheme as provided by the filter component 162, once the original transport path LPo or a portion of LPo has been generated. Thereby, the path selection scheme defines a sub-space of the entire transport path space associated with the three-dimensional scene and the light transport algorithm. The comparator component 170 can also compare 1400 light transport paths which have already been modified previously to enable cascaded modifications of already modified transport paths.

The sub-space includes transport paths which are subject to further manipulation. The path selection scheme can therefore be seen as a filter mechanism to separate such transport paths from the entire transport path space, which shall possibly be manipulated or adjusted to deviate from the original ray tracing-based computation. It may be desirable that not all transport paths satisfying the filter criteria are selected for manipulation. This can be achieved by assigning a selection probability to such transport paths matching the filter criteria, so that a matching transport path is selected only with the assigned probability. The probability assignment may be static or dynamic (e.g., varying in space or time).

If the particular light transport path LPo does not match the path selection scheme, then the particular (original) light transport path is left 1500 unchanged. In other words, in this case the comparator component 170 recognizes that the particular transport path does not match the filter criteria set by the pre-defined path selection scheme and, as a consequence, does not select the transport path for manipulation. If the particular light transport path LPo or portion thereof matches the pre-defined path selection scheme, the transport path or portion can be selected for modification according to the assigned probability, if such a probability is assigned. Otherwise the path or portion may always be selected. In one embodiment, all matching transport paths or respective portions of transport paths can be selected. If selected by the comparator 170, a particular portion of the particular (original) light transport path is modified 1600 by the path-modification component 151 in accordance with the modification request as defined by the modification editor component 160. The path-modification component 151 may also be implemented as an integral part of the transport path generator 150 because functions of the generator 150 can be reused for generating a modified transport path.

As a result, the modified light transport path LPm is generated in response to the modification request. In the example of FIG. 3 the original transport path LPo was reflected from the surface of the virtual object VO2 to VO3, from where it contributed to the computation 1700 of the pixels according to the virtual observer's view point. It is assumed that the path selection scheme is defined to better illuminate the virtual object VO4. To this end, a sub-space of transport paths (as defined by the path selection scheme) originally being directed to VO3 may now be redirected to the virtual object VO4, and therefore result in a different contribution to the pixel values of the image generated for the observer's viewpoint. In case the modified transport path matches another path selection scheme, the already modified transport path may be subject to a further modification, accordingly.

Optionally, prior to the comparison step 1400, the computer system may receive 1300 the path selection scheme from a user via a light editing user interface of the selector component 161. For example, the light editor tool which may be part of the modification editor component 160 may support a drag and drop function for the user to drag an original target area (e.g., VO3) to a new target area (e.g., VO4). The editor tool may also be implemented with another component or as a component by itself. In this embodiment, the original target area serves as the selector 161, defining which transport paths are subject to modification. All transport paths originally interacting with the original target area are identified by a filter component 162 and can then be dragged to the new target area to interact with the corresponding virtual object.

In the example embodiment of FIG. 3, for each transport path the accumulation component 152 computes 1700 its contribution to a respective pixel location of the virtual observer. In alternative embodiments (not shown), the computation may be directed to the contribution to a pixel of an environment map or to a memory buffer storing the result of the ray tracing-based light transport algorithm. That is, in case the transport path does not match the path selection scheme, the contribution of the original transport path LPo is computed by the accumulation component 152, and if the transport path matches the path selection scheme, the transport path is manipulated accordingly and the contribution of the manipulated transport path LPm is computed in the accumulation component 152. The results of the computation of the accumulation component 152 can then be visualized 1800 for the user through the I/O means 120 (e.g., an appropriated display device).

Optionally, the system 100 can store the manipulated picture, parts of the picture, or intermediate data for generating the picture or parts of it, as well as sequences of the aforementioned of the three-dimensional scene on a storage medium 196. The picture data storage component 192 can be an integral component of system 100 or it may a remote storage component (e.g., a server reachable over a network, such as a local area network or a wide area network), which is communicatively coupled with the system 100.

The control component 180 is used for controlling and monitoring the system 100. It can instruct the transport path generator 150 to generate transport paths which are required to generate the picture/image, parts of the picture, or intermediate data for generating the picture or parts of it, as well as sequences of the aforementioned of the three-dimensional scene. It can further instruct the modification editor 160 (e.g., to visualize transport paths or to generate a path selection scheme based on a user defined path selection). The control component 180 can receive the output of the accumulation component 152 (e.g., to monitor a progressive rendering). A person skilled in the art can implement further functions in the control component 180 which are needed to let the components of system 100 interact in the disclosed manner.

In one embodiment, the particular light transport path is visualized 1800 for the user through a corresponding graphical representation (e.g., by using the visualization component 163) on the display means 120 of the computer 130. For example, each transport path may be represented as individual light rays. In another embodiment, multiple transport paths may be represented by a single graphical representation wherein the single graphical representation is computed by averaging deviating directions of the multiple transport paths. The visualization of transport paths can be implemented as an overlay to the visualization of the three-dimensional illuminated virtual objects. The visualization of the light transport paths through the editor component may facilitate the inspection and editing of selected transport paths and respective transport phenomena.

The steps from generating 1200 the particular transport path to computing 1700 its contribution (i.e., the steps 1200, 1400, 1500 or 1600, and 1700) are then repeated for a plurality of light transport paths.

Turning now again to FIG. 3, the particular light transport path LPo originates at the (at least one) light source L and ends at the virtual observer O. LPo is an element of the entire path space associated with the three-dimensional scene 200. The entire path space is defined by the ray tracing-based light transport algorithm, i.e., the set of all possible paths that can be created in the three-dimensional scene by the given algorithm.

In one embodiment, Heckbert's regular expression-based path notation (cf. “Adaptive radiosity textures for bidirectional ray tracing”, HECKBERT, C., 1990, Computer Graphics (Proc. SIGGRAPH) 24, 4, 145-154) or an extension thereof may be used to provide a differentiation of individual path interactions. Users can select transport paths according to this notation. Path classification according to Heckbert's path notation, or variants of it, may distinguish between diffuse (D), glossy (G), and specular (S) interactions. In the example, VO1 and VO3 show diffuse interaction D, whereas VO2 shows glossy interaction G and VO4 shows specular interaction S.

In another embodiment, the user can specify a specific material which should be present in at least one interaction of the light transport path LPo or a portion of LPo. Furthermore, the user may specify a specific order of materials which have to be present at the respective vertices of LPo, in the same order.

In another embodiment, the user may specify a region of interest on a surface (e.g., the front surface of VO3) using sketching, painting, or other interface metaphors. Transport paths whose vertices (i.e. interaction locations) fall into this region are classified as being selected.

As a consequence of the transport path selection and manipulation, the original transport path LPo is redirected from VO3 with a glossy interaction to VO4 with a specular interaction from where now the modified transport path LPm takes part in the pixel contribution computation for the virtual observer.

FIG. 4 shows an example of transport path manipulation according to an embodiment of the invention. The virtual light source L′ emits light for which a plurality of transport paths SLP is generated. For simplicity, FIG. 4 shows only two paths SPS as solid boundary lines. In the example, the transport paths between the solid boundary lines SLP defined a sub-space of the entire transport path space. The plurality of transport paths SLP interacts with a virtual glass sphere VO1′. The virtual glass sphere has optical properties which lead to a corresponding refraction of light, changing the direction of the transport paths when entering the glass sphere and when exiting the glass sphere. A focusing effect is achieved and the transport paths SLP are bundled on the surface of a virtual mirror VO2′.

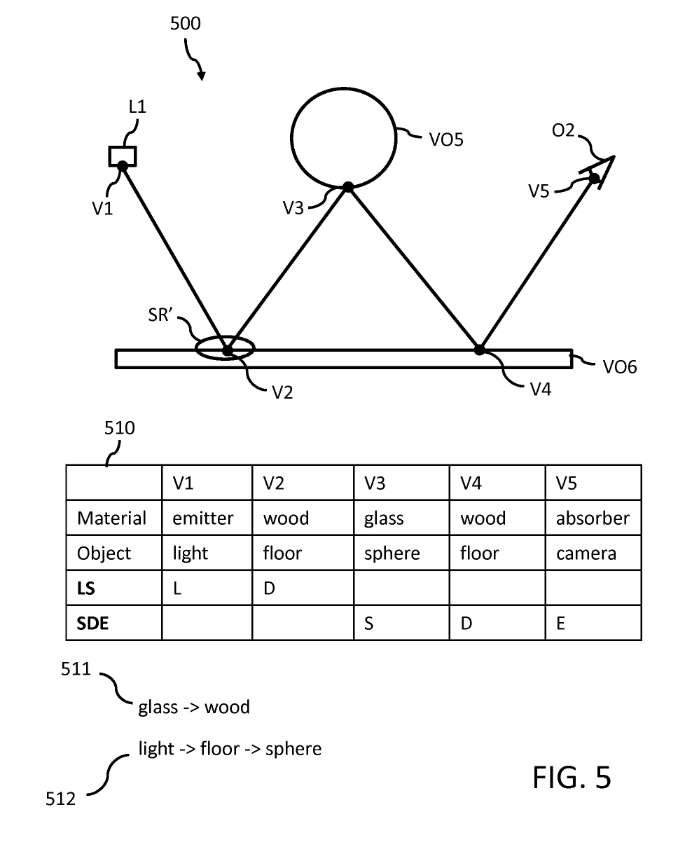

A typical transport path editing session may start with selection and filtering of a transport effect. For example, the user may define a region of interest SR by sketching, placing a bounding volume around the target area, or selecting objects (e.g., glass sphere VO1′ and reflecting surface VO2′) which interact with the transport path SLP. The user may refine the selection by additional criteria, such as the regular expression notation as disclosed in the description of FIG. 5.

Manipulation of light transport paths provides focused control over distinct lighting features, e.g. dragging a caustic or moving a reflection. The underlying concept is to use the selection mechanism to define a sub-path, e.g. to select all paths starting at a particular light source with two refractions thereafter; or to select all paths ending at the virtual observer whose last interaction was with a particular scene object. For example, these selections can be specified using a user interface by selecting interacting objects or by specifying paths with regular expressions. Other appropriate selection mechanisms may be used by a person skilled in the art. Optionally, the selection may also include a specification that the vertices of the sub-paths have to reside within a certain selection region.

The following description assumes manipulation of a transport path starting from a virtual light or ending at a virtual observer can be handled analogously. Manipulation may operate as follows: first, the transport phenomenon is selected defining the light transport sub-paths that are affected during redirecting as described above. The user can then choose to manipulate only path vertices within the source region, or all vertices matching the path selection scheme.

The manipulation of the at least one affected path vertex can be a translation of the vertex, changing the direction of the path segment ending at this vertex (which ultimately affects the vertex location as well), or specifying a target region and a mapping from the selection to the target region. Other transformations and combinations of transformations are possible if appropriate. Transformations can be specified in absolute coordinates or relative to the object.

Optionally, transformations can also be animated (e.g., by specifying their attributes at key animation frames or using any other animation technique known by the skilled person, such as for example, rigid body or fluid simulation).

In general, the modification request for manipulating a generated particular light transport path specifies the modification of a transport phenomenon of the particular light transport path at at least one affected vertex of the particular light transport path. In the example of FIG. 4, the transport phenomenon relates to the direction of at least a portion of the particular light transport path starting at the at least one affected vertex (e.g., at the light exit points of the glass sphere VO1′). In the example, the portion is redirected from a first virtual source region (e.g., SR of VO2′) to a second virtual target region (e.g., TR of VO2′). Virtual target and source regions are not bound to specific virtual objects in the three-dimensional scene. That is, the proposed manipulation method also works in case of spatially separated objects, as it is the case in FIG. 3 regarding the virtual objects VO3 and VO4. Illumination features can be transferred between these separated virtual objects.

The edited transport phenomenon may also relate to an optical property of a surface of the at least one affected vertex. For example, the first target object (which is originally hit by the transport path) may have a glossy surface and the new target object (which is hit by the transport path after manipulation) may have a specular surface. Or, for example, the two target objects may have different colors.

FIG. 5 illustrates the selection and filtering process of light transport paths. The figure shows a virtual scene 500 consisting of virtual objects (as in the previous figures) and a light transport path starting at the virtual light source L1, including the vertices V1, V2, V3, V4, and V5, and ending at the virtual observer O2. Furthermore, it shows a selection region SR′ placed close to the vertex V2.

The upper part of table 510 shows the material and object designations of the respective path vertices. In the example, vertex V1 belongs to the virtual light source L1 which includes an “emitter” material and is an object of type “light”. Vertex V2 includes a “wood” material and it has the object type “floor”. Vertex V3 includes a “glass” material and has the object type “sphere”. Vertex V4 is part of the same virtual object VO6 (floor) as vertex V2. Vertex V5 is part of the virtual observer O2 and includes an “absorber” material and has the object type “camera”.

In one embodiment, the path is selected for manipulation, because at least one of its vertices lies within the user-specified selection region SR′. The regular expressions defining respective path selection schemes can be modified and edited by the user via the modification editor of the computer system.

In another embodiment, paths may also be selected according to their path notation using regular expressions in Heckbert's notation (or extensions thereof). The lower part of table 510 shows two rows with two regular expressions “LS” and “SDE” in the first (left) column. Furthermore, it shows which sub-paths of the entire transport path (V1 V2 V3 V4 V5) are matched by the two regular expressions. Table 510 is only used for convenience of explanation. Table 510 does not need to be stored anywhere in the system for operating embodiments according to the invention.

The first regular expression LD matches the segment including vertices V1, V2, since vertex V1 is an interaction with the light source L1 (L) and the second vertex V2 is an interaction with a diffuse surface (D). Hence, the sub-path (V1 V2) is matched by the regular expression LD. The selection can optionally be refined using the selection region SR′, e.g. such that only paths matching LD are selected whose second vertex lies within the selection region SR′. The path (V1 V2 V3 V4 V5) matches this refined selection scheme and is selected for modification as illustrated in FIG. 5.

The second regular expression SDE matches the sub-path (V3 V4 V5). Optionally the user can again refine the selection scheme so that the path vertex preceding V3 lies within the selection region SR′. That is, vertices V3 to V4 (SD) are matched by the regular expression, vertex V5 is an interaction with the virtual observer O2 (e.g., eye, sensor, etc.) (E), and V2 is matched by the selection region SR′. Hence, the sub-path (V2 V3 V4 V5) is matched by the regular expression SDE and the selection region SR′ and selected for modification as illustrated in FIG. 5.

In one embodiment of the disclosed method, the transport path may be selected for manipulation, because it matches the given user specification of material order 511, i.e. having an interaction with the glass material before an interaction with the wood material.

In one embodiment of the disclosed method, the transport path may be selected for manipulation, because it matches the given user specification of object order 512, i.e. having an interaction with the “light” object, then the “floor” object, and then the “sphere” object.

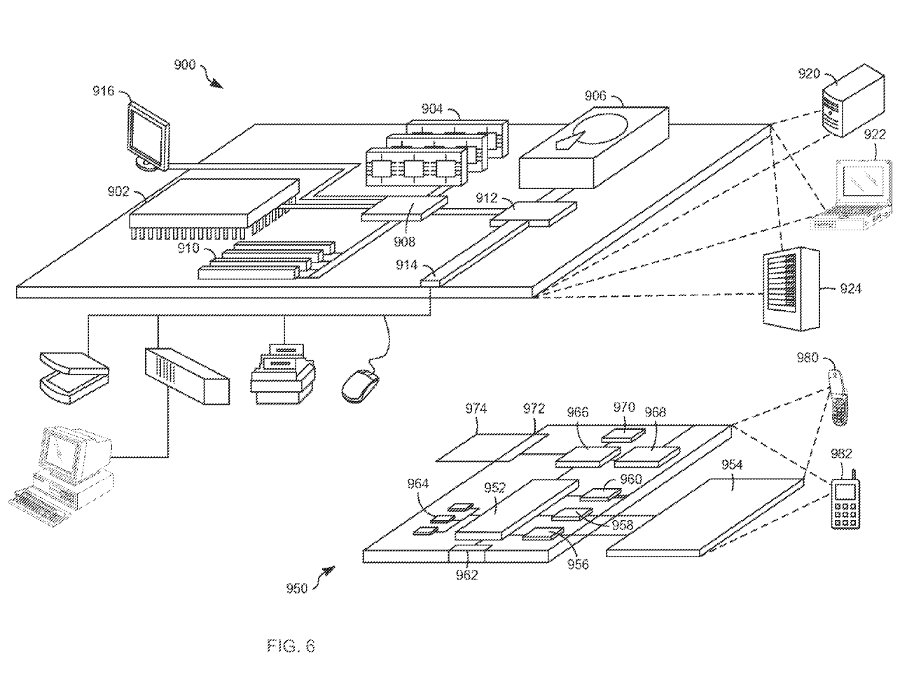

FIG. 6 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer implemented method for light transport path manipulation, comprising:
receiving a three-dimensional virtual scene description, the scene description including location properties and optical behavior properties of a plurality of three-dimensional virtual objects and at least one virtual light source;
generating at least one portion of a particular light transport path within the three-dimensional scene by applying a ray tracing based-light transport algorithm to the scene description;
comparing the at least one portion of the particular light transport path with a path selection scheme, the path selection scheme defining a sub-space of the entire path space, the entire path space being defined by the ray tracing-based light transport algorithm describing the distribution of light in the three-dimensional scene;
if the at least one portion of the particular light transport path does not match the path selection scheme, leaving the least one portion of the particular light transport path unchanged;
if the at least one portion of the particular light transport path matches the pre-defined path selection scheme, modifying the at least one particular portion of the particular light transport path in accordance with a modification request associated with the orientation of at least one particular portion of the particular light transport path;
computing a contribution of the particular light transport path to a pixel location of an image of the three-dimensional scene; and
repeating the steps generating to computing for a plurality of light transport paths.

2. The computer implemented method of claim 1, wherein the at least one portion of the particular light transport path is selected for modifying according to a probability associated with the at least one portion of the particular light transport path.

3. The computer implemented method of claim 1, wherein the particular light transport path originating at the at least one light source and ending at a virtual observer is an element of the entire path space associated with the three-dimensional scene.

4. The computer implemented method of claim 1, further comprising:
prior to comparing, receiving the path selection scheme from a user via a light editing user interface.

5. The computer implemented method of claim 1, further comprising:
visualizing the particular light transport path.

6. The computer implemented method of claim 1, wherein the path selection scheme is based on a regular expression.

7. The computer implemented method of claim 1, wherein the path selection scheme is based on the order of transport path interactions with virtual objects.

8. The computer implemented method of claim 1, wherein the ray tracing-based light transport algorithm is a path sampling algorithm configured to sample the transport path space selected from the group of: approximate methods, Monte Carlo methods, Path Tracing, Light Tracing, Bidirectional Path Tracing, Quasi-Monte Carlo methods, Markov Chain Monte Carlo methods, sequential Monte Carlo methods, population Monte Carlo methods, approximate methods, hybrid methods, density estimation methods, Vertex Connection and Merging, and regularization methods.

9. The computer implemented method of claim 1, wherein the modification request specifies a modification of a transport phenomenon of the particular light transport path at at least one affected vertex of the particular light transport path.

10. The computer implemented method of claim 9, wherein the transport phenomenon relates to the direction of the at least one particular portion of the particular light transport path starting at the at least one affected vertex, the portion being redirected from a first virtual target object towards a second virtual target object wherein, within the three-dimensional scene, the first virtual target object is spatially separated from the second virtual target object.

11. The computer implemented method of claim 1, wherein the steps generating, comparing, leaving or modifying, and computing are applied to the modified light transport path for a further path selection scheme if at least a portion of the modified light transport path matches the further path selection scheme.

12. A computer program product comprising instructions that when loaded into a memory of a computing device and executed by at least one processor of the computing device executes the following steps:
receiving a three-dimensional virtual scene description, the scene description including location properties and optical behavior properties of a plurality of three-dimensional virtual objects and at least one virtual light source;
generating at least one portion of a particular light transport path within the three-dimensional scene by applying a ray tracing based light transport algorithm to the scene description;
comparing the at least one portion of the particular light transport path with a path selection scheme, the path selection scheme defining a sub-space of the entire path space, the entire path space being defined by the ray tracing-based light transport algorithm describing the distribution of light in the three-dimensional scene;
if the at least one portion of the particular light transport path does not match the path selection scheme, leaving the least one portion of the particular light transport path unchanged;
if the at least one portion of the particular light transport path matches the pre-defined path selection scheme, modifying the at least one particular portion of the particular light transport path in accordance with a modification request associated with the orientation of at least one particular portion of the particular light transport path;
computing a contribution of the particular light transport path to a pixel location of an image of the three-dimensional scene; and
repeating the steps generating to computing for a plurality of light transport paths.

13. The computer program product of claim 12, wherein the at least one portion of the particular light transport path is selected for modifying according to a probability associated with the at least one portion of the particular light transport path.

14. The computer implemented method of claim 12, wherein the particular light transport path originating at the at least one light source and ending at a virtual observer is an element of the entire path space associated with the three-dimensional scene.

15. The computer program product of claim 12, configured to cause the processor to further execute:
prior to comparing, receiving the path selection scheme from a user via a light editing user interface.

16. The computer program product of claim 12, configured to cause the processor to further execute:
visualizing the particular light transport path.

17. The computer program product of claim 12, wherein the path selection scheme is based on a regular expression.

18. The computer program product of claim 12, wherein the path selection scheme is based on the order of transport path interactions with virtual objects.

19. The computer program product of claim 12, wherein the ray tracing-based light transport algorithm is a path sampling algorithm configured to sample the transport path space selected from the group of: approximate methods, Monte Carlo methods, Path Tracing, Light Tracing, Bidirectional Path Tracing, Quasi-Monte Carlo methods, Markov Chain Monte Carlo methods, sequential Monte Carlo methods, population Monte Carlo methods, approximate methods, hybrid methods, density estimation methods, Vertex Connection and Merging, and regularization methods.

20. A computer system for light transport path manipulation, comprising:
an interface component adapted to receive a three-dimensional virtual scene description, the scene description including location properties and optical behavior properties of a plurality of three-dimensional virtual objects and at least one virtual light source;
a light transport path generator component adapted to generate at least one portion of a particular light transport path within the three-dimensional scene by applying a ray tracing-based light transport algorithm to the scene description;
a comparator component adapted to compare the at least one portion of the particular light transport path with a path selection scheme, the path selection scheme defining a sub-space of the entire path space, the entire path space being defined by the ray tracing-based light transport algorithm describing the distribution of light in the three-dimensional scene;
a modification component adapted to leave the at least one portion of the particular light transport path unchanged if the at least one portion of the particular light transport path does not match the path selection scheme, and to modify the at least one particular portion of the particular light transport path in accordance with a modification request associated with the orientation of at least one particular portion of the particular light transport path if the at least one portion of the particular light transport path matches the pre-defined path selection scheme;
an accumulation component adapted to compute a contribution of the particular light transport path to a pixel location of an image of the three-dimensional scene; and
a control component adapted to repeatedly invoke the light transport path generator, comparator, modification, and accumulation components for processing a plurality of light transport paths.
